(19) United States
(12) Patent Application Publication
(10) Pub. No.: US 2017/0124288 A1
(43) Pub. Date: May 4, 2017

(54) INTEGRATED PHYSICAL ACTIVITY LEVEL (I-PAL) MEASUREMENT AND TRACKING IN ADOLESCENTS AND OLDER TEENAGERS

(71) Applicant: RAMARAO GUNDLAPALLI, SOUTH BARRINGTON, IL (US)

(72) Inventor: RAMARAO GUNDLAPALLI, SOUTH BARRINGTON, IL (US)

(21) Appl. No.: 15/252,974

(22) Filed: Aug. 31, 2016

Related U.S. Application Data
(60) Provisional application No. 62/214,622, filed on Sep. 4, 2015.

(51) Int. Cl. G06F 19/00

(52) U.S. Cl. CPC G06F 19/3481; G06F 19/3418; G06F 19/3475

(57) ABSTRACT

Described are systems that include at least one sub-system to track, measure, monitor and reward adolescents and young adults for performing daily physical activities, which include before-school, in-school, after-school, sports and activities of daily living. The system offers adolescents the opportunity to track their integrated physical activity level (I-PAL) scores over their adolescent years. Also described are systems that include at least one sub-system that supports the four pillars of juvenile diabetes management, which include managing medications, monitoring blood glucose levels, documenting eating habits and tracking integrated physical activity levels. Another embodiment describes systems to manage childhood obesity that includes documenting eating habits, tracking integrated physical activity levels, offering educational and motivational information and managing comorbidities related to childhood obesity. Also included are embodiments that describe a system to help physical education teachers in schools to help students set goals, monitor class progress, objectively grade the students performance and provide a lifetime score that can be carried from one grade level to the next. The system accomplishes this by aggregating physical acidity data from a variety of sources. The described systems also allow adolescents and young adults to form health groups and socialize their progress in a safe environment to motivate themselves and their social peers by setting health goals.

### PROVISIONAL PATENT APPLICATION

In accordance with 35 U.S.C. §119(e), this non-provisional application is being amended to contain a specific reference to the provisional application No. 62/214,622 titled “INTEGRATED PHYSICAL ACTIVITY LEVEL (I-PAL) MEASUREMENT AND TRACKING IN ADOLESCENTS AND OLDER TEENAGERS” submitted on 4 Sep. 2015.

The present applications claims priority to the earlier filed provisional application having Ser. No. 62/214,622 titled “INTEGRATED PHYSICAL ACTIVITY LEVEL (I-PAL) MEASUREMENT AND TRACKING IN ADOLESCENTS AND OLDER TEENAGERS” and hereby incorporates subject matter of the provisional application in its entirety.

### FIELD OF INVENTION

The current invention relates to the field of physical activities, more specifically to the field of measuring, tracking anti monitoring of physical activity levels of adolescents and older teenagers using specialized algorithms incorporated into a highly interactive mobile and web-based software application that are computed and accessed on a desktop computer or mobile computer or other handheld computing devices. The invention also relates to wearable devices used to measure, track and monitor physical activities of adolescents and older teenagers. Embodiments of the invention also relate to the field of juvenile diabetes management which incorporate physical activity tracking. Aspects of the invention also relate to the field of childhood obesity management which incorporate physical activity tracking. Additional aspects of the invention relate to educational institutions that offer physical education classes and allow for tracking of physical activity levels. Additional aspects of the invention relate to the ability for adolescents to form and compete within teams to achieve rewards once their physical activity goals have been met.

### BACKGROUND OF THE INVENTION

Tracking and monitoring the physical activity levels of adults using devices such as Fitbit, Jawbone, Misfit and smart watches has increased in popularity over the past few years, However, this growth does not include an important segment of the population - adolescents (ages 10-18 years) where automated physical activity tracking systems available today are ineffective and cumbersome.

In 2013, the Institute of Medicine published the concept of “whole-of-school” (before school, in school and after school) to increase Physical Activity Levels (PAL) of adolescent and older teenagers.⁷ TeenFitNation proposes that this concept be broadened to include Activities of Daily Living (ADL). This will allow for the measurement and tracking of the adolescents from an “integrated view,” rather than segmenting personal and school life. To date, tracking the physical activities of adolescents is done only for short durations of time and for specific activities using three methodologies: surveys, objective measurements, and observations. Long-term measurement and tracking of physical activity in adolescents as an integrated approach has not been attempted due to limitations in technology and data collection methods. With no baseline for Integrated Physical Activity Levels (I-PAL) for adolescents, there are no means to proactively improve health and wellness.

There is a critical need to address this adolescent and young adult population as physical inactivity of today's adolescents will lead the next generation of adults to experience health conditions such as obesity, type-2 diabetes, hypertension, liver disease, asthma, cardiovascular disease, sleep apnea and some cancers. For today's generation, it can reduce the quality of life, self-esteem, and potentially academic performance.¹²

Although obesity prevention and juvenile diabetes is a multifactorial issue, a good first step is to measure and monitor the Physical Activity Level (PAL) of adolescents and older teens. This is key to understanding obesity and diabetic trends, which then can enable follow-up measures to mitigate related health affecting disease effects. The I-PAL becomes an integral part of the health management

In adolescents and older teenagers, monitoring using wearable devices has been extremely difficult since children tend to not wear the monitors for an extended period of time.⁹ Also, the growth and development of an adolescent occurs on a daily basis. Their linear and ponderal growth do not occur at exactly commensurate rates and consequently, their body mass index (BMI) is not constant throughout childhood.¹⁰ The predictive equations used by commercially available wearable monitors assume physical maturity of the individual and use empirical relationships to derive the total energy expenditure (TEE). Moreover, adolescent energy requirements vary throughout their puberty.¹¹ This has made calorie counting an almost impossible task, since TEE and basal energy expenditure (BEE) varies by age and BMI. The dietary intake also changes through puberty, which makes it difficult to standardize intake and expenditure calculations.¹¹

The ability to continually measure and track activity levels of adolescents and older teenagers can motivate them to establish a healthier life style. Applying TeenFitNation's proprietary methodology to create individual I-PAL scores will help adolescents being monitored to set goals that can be tracked over time.

The pressures of maintaining good health (emotional and physical) and good academics (math, science and reading) is taking away time from physical activities. With the time pressures, adolescents and older teenagers are unable to devote to prescribed (or dedicated) exercise and/or physical activity time. This comes at a time when sufficient evidence proves that physical activity improves health and academic performance in adolescents.⁷ Parents, guardians, coaches, mentors and peers can encourage a more active regimen or can simply offer moral support as they see improvement.

### SUMMARY OF THE INVENTION

A system for tracking, measuring and monitoring using specialized age specific activity algorithms combined with computing devices for adolescents and older teenagers, different from those used to track adults is described. There are primarily five (5) reasons for the inability to use automated tracking systems for adolescents and teenagers.
1. Automatic trackers that utilize pedometers and accelerometers always underestimate the step counts during slow walking.¹³ This may be because of the varying stride lengths with different age groups of children.¹⁴ Most of the activities performed by younger adolescents such as free-play and climbing are better captured by tri-axial accelerometers, which are expensive to use and are not comfortable to wear.⁹
2. Adolescents tend to exhibit short bouts of medium to high intensity physical activity. Bailey et al. estimated that 71% of their time was spent in low intensity and 3.1% of time in high intensity activities. Also, the median duration of high intensity activities only lasts three seconds.¹⁵ Adults do not go through these varying intensity levels, and hence algorithms used to track adults are ineffective.
3. Heart rate (HR) to energy expenditure (based on VO2Max) of adolescents is not an accurate predictor since emotional stress, ambient temperature, humidity, and drugs can influence the HR. Also there may be day-to-day variations depending on the physical fitness of the adolescent. The VO2Max changes as the adolescent ages due to the growing cardiovascular system and cannot be normalized. This requires that the relationship between HR and VO2Max be calibrated on a regular basis using prescribed activities.¹⁶
4. TEE as a ratio of caloric intake is not accurate as the Recommended Dietary Allowance (RDA) can vary with age, weight, height, and activity level.¹¹ Nutrient needs for both males and females increase sharply during adolescence. These nutrient recommendations are based on chronological age categories as opposed to individual levels of biological development (growth and sexual maturation status) as per Stang et al.¹¹ Adult monitoring devices do not need to account for this change of physical development.
5. Schools and certain sports organizations prohibit adolescents and older teenagers from wearing accessories, especially during high intensity activities such as competitive and/or high contact sports.⁹ This provides for a situation of “no-data” to calculate TEE. These are the primary reasons wearable devices are unreliable and ineffective for adolescents.

To overcome the above issues surrounding adolescent physical activity tracking, TeenFitNation has developed a system for tracking and monitoring adolescents using specialized age, weight, and height and sex specific algorithms to be used on a computer and hand held computing devices. FIG. 1 provides an overview of the technology used to measure, monitor and determine the I-PAL of adolescents and provide feedback as to the lifestyle of the subject. This is based on all physical activities of the adolescents including, but not limited to, school physical education (PE), extra-curricular team and/or individual sports sessions and activities of daily living. The system used to calculate the PAL and TEE/BEE coefficients is specific to age, sex and BMI of the subject. Adolescents with a BMI greater than 25 have different considerations for the TEE/BEE calculations. This is done automatically, without interference to the adolescent.

Integrated physical activity levels (I-PAL) are a critical element in the management of childhood diseases such as juvenile diabetes, childhood obesity and their related comorbidities such as high blood pressure and high cholesterol, glucose tolerance, insulin resistance, breathing problems, and asthma, joint problems and musculoskeletal discomfort, fatty liver disease, gallstones, and gastro-esophageal reflux, psychological stress such as depression, behavioral problems, and issues in school, low self-esteem and low self-reported quality of life, impaired social, physical, and emotional functioning.

While solutions have been described for determining physical activity levels for adults with and without tracking devices, this present invention provides improved systems to specifically track, measure, monitor and reward adolescents and young adults for their daily physical activities. The invention also provides for methods to track physical activity as they relate to adolescent medical conditions such as childhood obesity and juvenile diabetes.

To create these systems, TeenFitNation researched and compiled information available from multiple sources including Dietary Reference Intakes,¹⁰ Institute of Medicine 2005,⁵ Compendium of Energy Expenditures for Youth,¹⁷ Gerrior et al. An Easy approach to Calculating Estimated Energy Requirements¹⁸ and various other sources.

These systems will be incorporated into the invention and accomplish the following:
1. Track physical activities on a regular (daily) basis over an extended period of time thereby exceeding the current limitations of research based (2-3 weeks) monitoring system currently used for adolescents.
2. Provide an avenue to capture before-school, in-school, after-school activities, and ADL to combine and obtain TEE per day.
3. Instead of measuring calories expended and steps for each activity, the new system measures metabolic equivalents (MET) appropriate for adolescents and creates an empirical relationship based on individual age, height, weight and sex.
4. Compensates for adolescent growth instead of standardizing based on age and gender only.
5. Provides feedback on adolescents' daily activity levels and classifies them as either: Sedentary (SA), Low Active (LA), Active (AA) and Very Active (VA) and compares data on a day-to-day, week-to-week, month-to-month and year-to-year basis.
6. Each adolescent acts as his/her own control based on “a-day-in-the-life” and can cumulatively increase their I-PAL scores throughout their adolescent years (ages 10-18 years).
7. Ability to reward adolescents and young adults by parents/guardians, physical education (PE) teachers, mentors and peers.

Another aspect of this invention will lie in the creation of a highly interactive web and mobile device based solution that will motivate the adolescent to track and record their daily physical activities. The software solution will offer such features as:
1. Run on a desktop computer, mobile computer and hand-held computing devices.
2. Ability to create a self-anime (an on-line version of the adolescent) to motivate, educate, appreciate and challenge the adolescent to increase their I-PAL scores.
3. Gamification of the application allows adolescent to play a game, set fitness-goals (levels) and obtain points/rewards when the goal have been achieved. The gamification could include methods to follow the anime through treks, trials and walks to encourage physical activities. The gamification could allow for individual activities or group activities with teams made up of friends and peers.
4. Ability to overcome the shortcomings of the paper and memory-based physical activity questionnaires often used by researchers to document and measure the PAL of children.¹⁹
5. Integrated Physical Activity Level (I-PAL) score: A lifetime customized score that indicates whether an adolescent or older teen has been physically active. Scores start at age 10 and cumulatively increase until subject is 18 years of age.
6. Ability to share I-PAL scores and offer healthy competitive and social interactions within peer groups to challenge the adolescent's physical activity skills.
7. Ability to integrate with automated physical activity tracking devices for adolescents and young adults who may have achieved physical maturity.

TeenFitNation will utilize a highly interactive mobile and web-based software application that incorporates the specialized algorithms to measure, monitor and track the I-PAL scores of adolescents and older teenagers (ages 10-18 years).

TeenFitNation's system solution will automatically calculate the I-PAL scor” by providing a simple and elegant approach for adolescents to enter the physical activities as they occur. Alternatively, for young adults, the data from fitness trackers such as Fitbits, Jawbone, Misfit's could be utilized to compute the I-PAL score. However, in the latter case, the raw data will be modified to reflect the physical activity of an adolescent.

The TeenFitNation system will provide ways to motivate the subjects through competitive rewards and “Peer to Peer” Interactions. The software solution will allow for physical activity tracking through both an online website and a mobile device. The system context diagram delineated in FIG. 1a will be the basis for development and deployment of the software solution within desktop computers, hand held computers and the like. The TeenFitNation application architecture will have a flexible user experience (UX) layer with responsive design and will be portable across multiple platforms. The application can be deployed as a web- based application and as a native application on the mobile device such as iTouch/iPad/iPhone or desktop computer or mobile computer. The mobile solution will be functional in offline modes to account for situations where network connectivity is sparse.

The system will allow adolescents and young adults to form groups or teams or both who share similar health and physical activity goals. The system will allow for broadcasting such health goals to the group based on individual metrics or performances.

The application will follow a 3-tier architecture framework with the top-tier supporting a front-end user interface (UI), a middle-tier with a service integration connecting to the back-end database. The TeenFitNation system will include the following core functionalities: (i) User administration to secure and control access to the application, (ii) Physical activity tracking/monitoring to generate an I-PAL score using algorithm processing, and (iii) Profile administration to manage user preferences, competitive tracking with peer-to-peer interaction and rewards to motivate the adolescents to consistently use the application. The UI will be developed using a HTML5 tool, which allows for creation of a cross-platform mobile application and a web based desktop application. The mobile application will then be packaged using the mobile framework to be deployed natively on mobile devices. The middle-ware layer will be developed in JavaScript/Node.js open source framework. The Database layer will be a NO-SQL document-based data store for all data related to user profiles, physical activities, I-PAL scores and rewards. The physical infrastructure for the middle-ware layer and the database layer will be hosted on the cloud platform run by Amazon Web Services (AWS). This will further reduce the human capital needs associated with harder administration functions like compute instance sizing, managing storage and performance monitoring. The AWS allows for dynamic capacity expansion based on use i.e., auto-scaling and, hence, will not require extensive infrastructure planning or a forecasting process and will meet the user scalability needs.

“A-Day-In-the-Life” of the adolescent is a compilation of daily or weekly physical activities that the adolescent or young adult performs on a regular basis. This allows the TeenFitNation system to create a baseline of the adolescents' activities and allows future data to be correlated against regularly scheduled activities. Regular activities could consist of once-a-week swimming, dance classes or taekwondo classes etc.

The TeenFitNation invention will provide the following information based on the daily physical activities of the subject:
1. Each adolescent/young adult will act as his/her own control based on their I-PAL obtained from their “A-Day-In-the-Life” of the subject. Since this I-PAL is obtained after discussion and consensus of the parent/guardian and physical education (PE) teacher, this will act as the control. Also, for those using an automated tracking device, no consensus is required.
2. For each adolescent, the daily I-PAL and the ratio of TEE/BEE will be calculated. Daily TEE/BEE ratios will be tracked and reported on a weekly, bi-weekly and monthly basis.
3. Depending on their daily I-PAL and TEE/BEE ratio, the subject will be assigned a classification for the day: Sedentary (SA), Low Active (LA), Active (AA) and Very Active (VA). This classification will be tracked on a weekly, biweekly and monthly basis.
4. Subjects within a given age group can be grouped and evaluated for daily I-PAL and TEE/BEE ratios.
5. Subjects within a given school grade can be grouped and evaluated for daily I-PAL and TEE/BEE ratios.
6. Average, range, median and standard deviations of I-PAL and TEE/BEE ratios will be calculated for a given group. These results will be shared with the parent/guardian and Physical Education (PE) teacher for confirmation from an observational perspective.
7. Correlation of I-PAL and TEE/BEE ratios to BMI of the subjects will be performed to determine any relationship.
8. Estimates of tho ratio of Before-School-to-In-School-After-school-to-ADL will be determined to understand the effects of whole of school-based physical education.

### BRIEF DESCRIPTION OF FIGURES

FIG. 1 provides an overview of the technology 100 used to measure, monitor and determine the I-PAL of adolescents and provide feedback as to the lifestyle of the adolescent.

FIG. 1a describes the system context diagram 110 delineated and will be the basis for development and deployment of the software solution within desktop computers, hand held computers and the like.

FIG. 1b describes how the system 120 allows for setting up as an individual or forming a specific health group or team and broadcasting the health goals to that group or team based on individual metrics achieved by the team member.

FIG. 2 shows the process flow 200 of how the adolescent/parent/mentor/guardian/teacher could interact with the invention used to measure, monitor and determine the I-PAL and grading.

FIG. 3 describes how the invention 300 will combine the four pillars associated with managing juvenile diabetes and the ability to measure and maintain good health.

FIG. 4 describes how the invention 400 will combine the four pillars associated managing childhood obesity and the ability to measure and maintain good health.

FIG. 5 shows one embodiment of the invention 500 where the physical activity levels are listed for adolescents from a team or a class for easy comprehension by the teacher/coach for grading of the students.

FIG. 6 shows one embodiment of the front-end user interface 600 where the adolescent will interact with the invention.

FIG. 7 shows one embodiment of the service integration layer 700 to the back-end services of the invention. The figure also details how the physical activity levels are tabulated based on the individual activities performed by the adolescents.

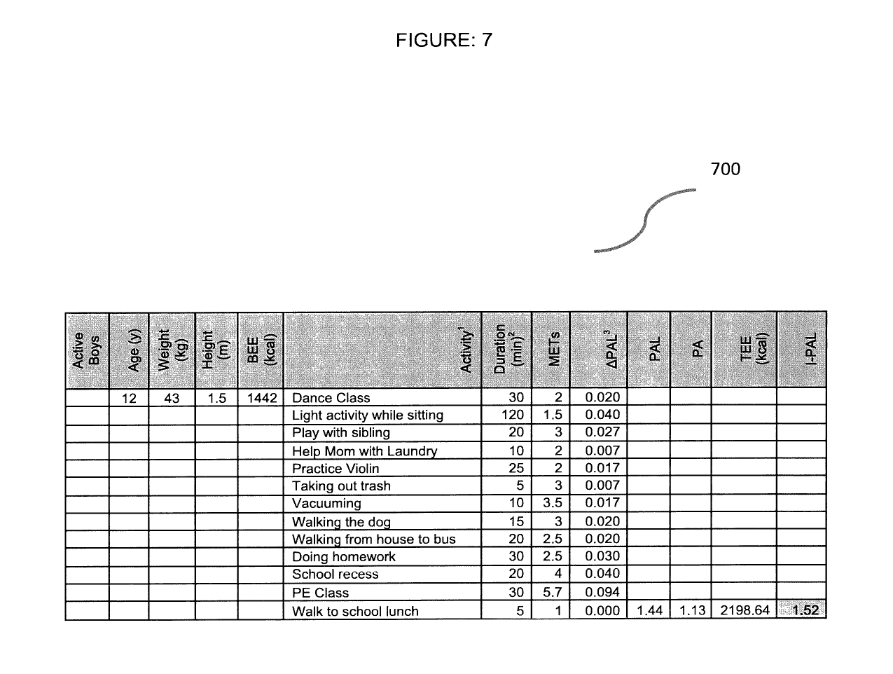

FIG. 8 details how the physical activity data 800 could be used as standardized metrics for comparison of the adolescent over a period of time similar to standardized math and science grades.

FIG. 9 details the methods used to create the adolescent's lifetime score 900 using parameters such as frequency of interaction with the invention, physical activity level, setting goals, achieving the goals. This embodiment can also be used to create the lifetime score of a class/team/friends to help in friendly competitions.

### DETAILED DESCRIPTION OF THE PREFERRED EMBODIMENTS

For the purposes of promoting the understandings of the principals of the invention, references will now be made to the embodiments illustrated in the drawings and specific language will be used to describe the same. It will nevertheless be understood that no limitation of the scope of the invention is thereby intended, and alternations and modifications in the illustrated invention and further applications of the principals of the invention as illustrated therein are herein contemplated as would normally occur to one skilled in the art to which the invention relates.

As disclosed above, the present invention describes systems that include at least one sub-system to track, measure, monitor and reward adolescents and young adults for performing daily physical activities, which include before-school, in-school, after-school, sports and activities of daily living. The system offers adolescents the opportunity to track their integrated physical activity level (I-PAL) scores over their adolescent years, preferably from ages 10 years to 18 years. The systems of the invention are conveniently deployed on a desktop computer, a mobile computer, a hand held computer and other personal computing devices.

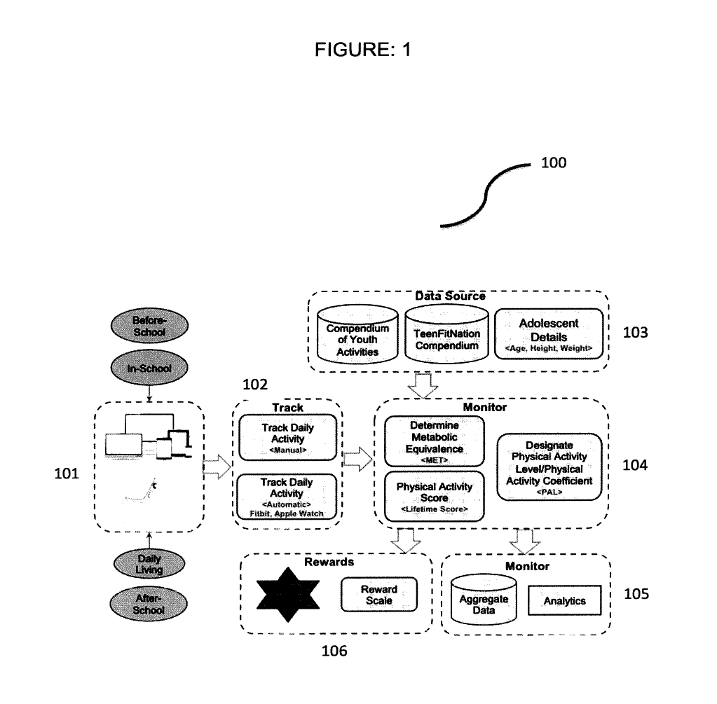

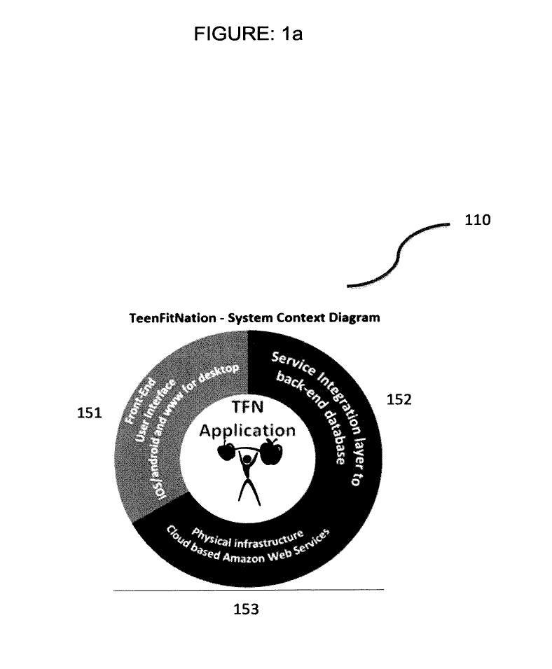

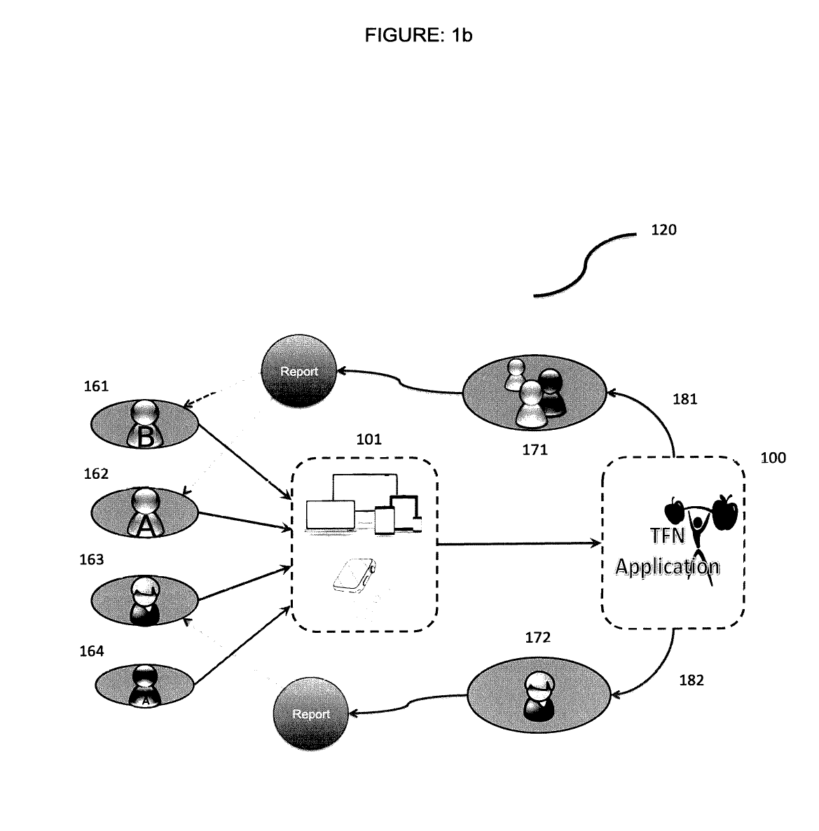

With reference now to FIG. 1, shown are details of the system and sub-systems related to the invention 100. The invention 100 consists of at least one sub-system, which works together as will be described below. The system allows the adolescent to use a computing device 101. The computing device 101 could be that of a desktop computer, a mobile computer, a hand held computer or similar devices. Depending on the computing device used by the adolescent, the physical activities performed by the adolescent are entered into the system to be tracked as shown by sub-system 102. For younger adolescents, this input maybe in the form of manual methods, for example with the help of their parents. For young adults, this maybe in the form of an automated tracking devices, which is worn by the adolescent, for example Fitbit, apple watch and the like. The physical activities that the adolescent performs on a daily basis, which may include, before-school activities, in-school activities, after-school activities, sports and activities of daily living (ADL) are entered into the system. These activities are entered in as much or as little details as the adolescent chooses. The resulting output from the invention will depend on the accuracy of the information provided. At a minimum, three parameters are required per activity of the adolescent, the name of the activity, for example: walking, running, doing the laundry, the duration of the activity in minutes, for example: 15 minutes, 30 minutes and the intensity of the activity, for example: light effort, moderate effort or high effort. The adolescent can either provide the information as the events happen during the day or at the end of each day.

In situations, where the adolescent may have scheduled activities for a day, for a week or for a month, the invention could be pre-programmed for such activities. Activities such as swimming class on Wednesdays, dance class on Sundays, karate classes on Mondays are considered scheduled activities and the system prompts the adolescent about competing that specific activity. These situations can be created using “a-day-in-the-life” method where the system would interview the adolescent at the time of registration. During the registration process, the adolescent is also asked for biometric information such as age, height, weight and sex as shown in 103. The child is asked to update this information on a regular basis, for example every 6 months, as adolescents are expected to continuously have both linear and ponderal growth through their adolescent years.

To further elaborate the invention 100, certain commonly used scientific terms will be used to describe the features. These scientific terms and variations to the scientific terms are evident for those skilled in the art and are provided below for reference.

| Number | Parameter | Units | Description |
|---|---|---|---|
| 1 | Age | Years | Can be reverse calculated from |
| | | | grade level in school |
| 2 | Weight | lbs | Will be converted into Kg in the |
| | | | algorithm |
| 3 | Height | Feet/ | Will be converted into meters |
| | | Inches | in the algorithm |
| 4 | Activity | N/A | Description of the activity from |
| | | | Youth Compendium and/or |
| | | | TeenFitNation Compendium |
| 5 | Duration | Minutes | Duration of the activity described |
| | | | above. Could be provided in increments |
| | | | of 15 minutes |
| 6 | Metabolic | MET | Metabolic equivalents of the activity |
| | Equivalents | | performed from the Youth Compendium |
| | | | and/or TeenFitNation Compendium |
| 7 | ΔPAL | N/A | Physical Activity impacts on |
| | | | energy expenditure |
| 8 | PAL | N/A | Physical Activity Level |
| 9 | PA | N/A | Physical Activity Coefficient |
| 10 | TEE | Kcal | Total Energy Expenditure |
| 11 | BEE | Kcal | Basal Energy Expenditure |
| 12 | I-PAC | Ratio | Integrated Physical Activity Coefficient. |
| | | | Improvement over a Couch Potato |
| 13 | EPOC Factor | N/A | Excess Post-exercise Oxygen |
| | | | Consumption Factor |
| 14 | TEF Factor | N/A | Thermic Effect of Food |
| 15 | I-PAL | Ratio | Integrated Physical Activity Level |
| 16 | I-PAL | N/A | Cumulative score of an adolescent |
| | Lifetime | | over the years |
| | Score | | |

The physical activity information and the biometric information provided by the adolescent are then compared against two compendiums available in the system 103. The Compendium of Youth Activities, published in collaboration with the National Institute of Health and the TeenFitNation Compendium of Youth Activities, complied by TeenFitNation. These two compendiums complement each other, as the former is not an exhaustive list of the activities performed by adolescents. TeenFitNation has expanded on the Youth compendium by incorporating common activities. Collectively this is considered the data source within the invention.

The Compendium is a repository of physical activities (PA) performed in various settings with their respective metabolic equivalent (MET). The definition for a MET is the ratio of work metabolic rate to a standard resting metabolic rate of 1.0 (4.184 kJ/kg/hour). One (1) MET is considered a resting metabolic rate obtained during quiet sitting. Activities are listed in the Compendium as multiples of the resting MET level and range from 0.9 (sleeping) to 18 METs (running at 10.9 mph). It is well known in the field that the adult compendiums cannot be used for predicting the MET for adolescents as the MET for a specific activity reduce as the age increases. Hence, a youth compendium was created to address such a need. Also, the time spent by adolescents in a certain activity are different that those of an adult and requires different considerations while calculating the MET.

All the days' physical activities performed by the adolescent, such as before-school, in-school, after-school, sports and activities of daily living are then converted into Metabolic equivalents (METS) with the sub-system 104. The total MET will be the cumulative MET of the day's activities by the child.

TeenFitNation sub-system 104 will also use this data to predict the Integrated Physical Activity Level (I-PAL) for the adolescent. This Physical Activity Level (PAL), along with the Physical Activity Coefficient (PA) will then be used to predict the Total Energy Expenditure (TEE) of the adolescent. It is to be noted that this TEE is specific for the adolescent whose activities and biometric data have been submitted to the system. Of note, is that this TEE is different than those calculated for adults. The TEE is calculated based on specialized algorithms that take into consideration the weight, height, sex of the child. Contrary to this, the adult physical activity levels are calculated based on a standardized curve, which are described in the literature as skeletally mature adults.

TeenFitNation sub-system 104, will also calculate the I-PAL for the adolescent for the given day. The I-PAL is the ratio of TEE and BEE for the adolescent. It describes how active the adolescent has been as compared to their Basal Energy Expenditure (BEE). To better elaborate the ratio, the BEE is the energy expenditure if the adolescent was a couch potato and did not perform any additional activities. A ratio of greater than one (1) would indicate activities done by the adolescent beyond that of daily living. For example, if the I-PAL is 1.52, the adolescent has had a 52% increase in total energy expenditure above the BEE.

The invention 100 and sub-system 104 uses the I-PAL to classify the adolescent into four categories depending on the days' physical activity level. The levels can be defined as Sedentary (SA), Low Active (LA), Active (AA) and High Active (HA). This classification will assist the adolescent and their parent, for example, to appreciate the level of physical activity the adolescent has participated in for the day.

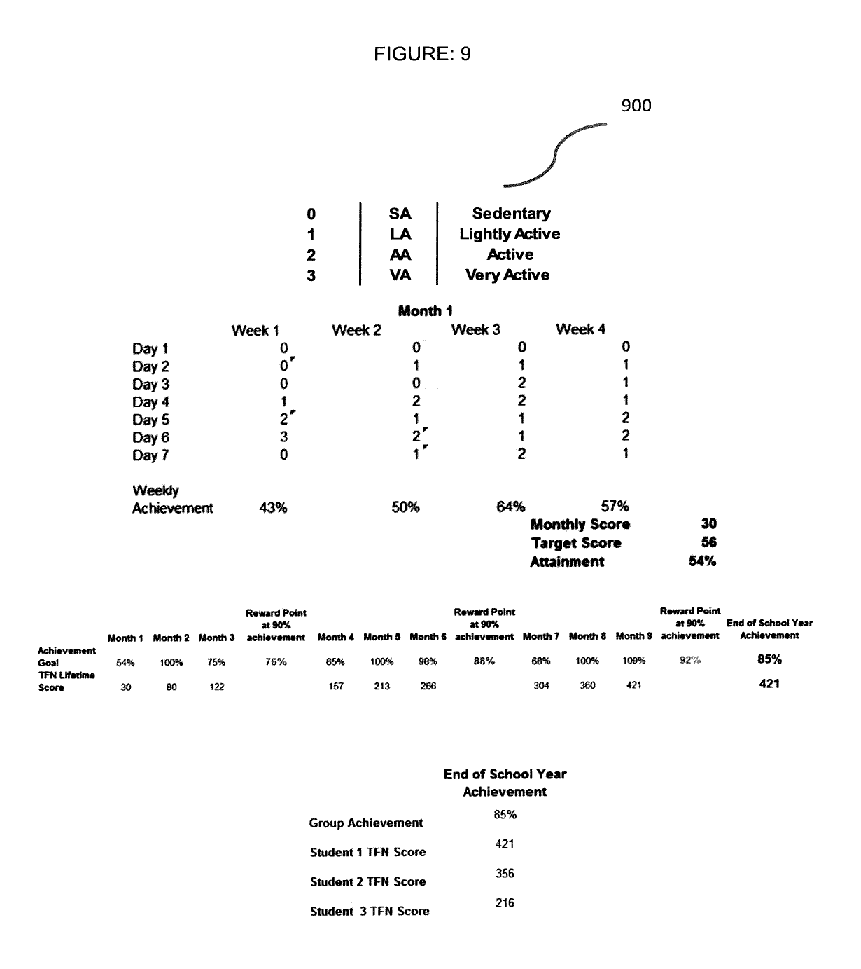

The invention 100 and sub-system 104 also uses the daily I-PAL to generate an I-PAL Lifetime Score as detailed in FIG. 9.

The information generated by sub-systems 102 and 104 are stored in the system 100 via databases that are specifically designed to easy retrieval and archiving from multiple computing systems. This is described in FIG. 1a, where 110 show the system context diagram of the invention 100. The system consists of three components, a front-end User Interface 151, middle Service Integration Layer 152 and a Physical Infrastructure layer 153.

User Interface 151 is used to interact with the adolescent in a highly interactive mode. This may include pleasing graphics, images, communications, colors and texts to keep the adolescent engaged while using the invention. The interface 151 is also used to gather the information from the adolescent and also display the predicted physical activity results to the adolescent. The Service layer 152 will help integrate multiple platforms being utilized in the invention 100. Systems such as iOS, Android, Google will be integrated using open source software. The Physical Infrastructure 153 will comprise the database and could be hosted on cloud-based platforms such as Amazon Web Services.

The information in the system is continually stored and archived in the Physical Infrastructure 153. This allows for the invention 100 to continually monitor the adolescent's physical activities over a week, over a month, over a quarter and over a year. It is also possible to compare the physical activities of the adolescent from year to year. This is performed in sub-system 105. As many adolescents use the invention 100 across the country and the world, the invention 100, could create comparative data of physical activity levels for example, across different classes with in a school, compare different schools, compare different school districts, compare different states, compare different countries and different continents. The invention 100 can also compare seasonal data between adolescents, such as physical activities between summer months and winter months. Additionally, the invention 100 can compare data between different cultures across the countries and the influence of financial support and accessibility to play areas and equipment. In certain cases, the invention 100 could compare physical activities of schools from inner cities to the more affluent sub-urban schools.

The information collected and created can also be used to project the needs of adolescents to improve their physical activities.

The invention 100 and subsystem 104 allow for the adolescent to set goals associated with their physical activities. These goals can be normal or stretch goals for the adolescent. These goals can be set by themselves or with the help of adults who can encourage and motivate them. The goals can be set as individual activities for a day or as an I-PAL to achieve. For example, an ideal goal can be to move from Low Active (LA) to Active (AA). Alternatively, a goal can be to increase my I-PAL from 1.40 to 1.50. Alternatively, a simple goal will be to increase the intensity of an activity from moderate to high, in another example, the goal maybe to extend the time of an activity from 15 minutes to 30 minutes.

The subsystem 104, then uses these goals set by the adolescent to determine if they have met their goals, for example daily, weekly or monthly goals. This information is also continuously stored in the database and can be used to evaluate the progress the adolescent is making in achieving their goals.

In addition to individual goals set by the adolescent, the system 100 allows for adolescents to form groups or teams. These groups and teams can be for example: friends who share the same interest, or friends who want to achieve similar goals. Additionally, a class of students, a scout troop, sporting team such as soccer, football or volleyball, may form the groups. Teams can also be formed of adolescents who have similar medical conditions such as juvenile diabetes and or childhood obesity. Parents or guardians of adolescents who share similar interests could also form groups. Also, a family can form a group and set goals for the team.

For such groups, FIG. 1b describes a system 120, where individuals 161, 162, 163 and 164 can record the physical activities peifthmed Into the sub-system 101 to be tracked as shown by sub-system 102. The TeenFitNation application system 100 then compiles the Integrated Physical Activity Level (I-PAL) either of the team 181 or of the individual 182. This information is then broadcast as report 171 to a group, if the individual is part of a group or an individual report 172 if not part of the group. These groups 172 can then be used to compare or compete with other groups who have similar goals.

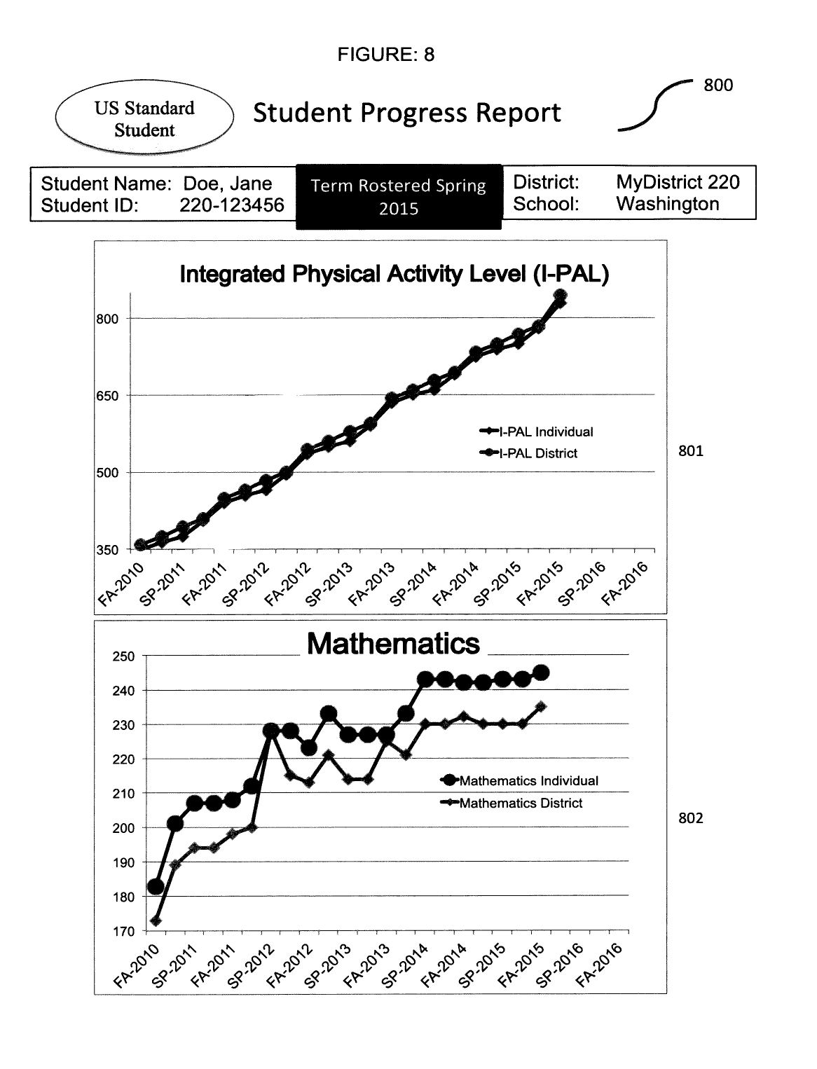

During an academic year, a school tracks and monitors the progress of an adolescent in subjects such as mathematics and science. FIG. 8 shows an example of a Student Progress Report 800 where the students' scores in standardized tests for mathematics 801 and science 802 are tracked and plotted. Usually, these scores are plotted along with the school district average for that particular test. The Report 800 also sets performance goals for the adolescent based on the capabilities of the next term. TeenFitNation invention 100 and sub-system 105 will offer an opportunity for schools to set individual physical activity goals and indicate the performance of the adolescent compared to district averages as shown in 803. It can be duly appreciated that adolescent physical activities are dependent on the individual capacity, physical and mental ability and the willingness to perform those activities. Considerations must be given for these cases and goals must be set accordingly. For example, for a physically and mentally normal adolescent the target maybe 10,000 steps per day, however, for an obese adolescent the goals could be 5000 steps per day. The comparison is made based on their ability to achieve their own goals verses a standardized goal.

Another aspect of the invention 100 and subsystem 104 is to offer a Lifetime Score for the adolescent as he continues to perform physical activities throughout their adolescent years. Adolescent years are generally considered in this case to be between the years 10 through 18. This allows the adolescent to be aware of their progress through the years and provide an opportunity to continually improve their physical activity levels. The lifetime score could take into consideration factors such as setting goals, achieving those goals, enrolling in team challenges, having friendly competitions with friends, the frequency of logging into the system, eating healthy, taking educational quizzes related to physical health, understanding the harmful effects of drugs, alcohol and smoking and refraining from them etc.

An example of a method of creating a lifetime score to the adolescent is provided in FIG. 9. In this example, the adolescent is tracked through an academic school year and the report 900 is created based on the adolescent's I-PAL and the ability to achieve the physical activity goals. The report 900 classifies the adolescent into one of four levels as described before. This information is then related to the goals that were set, how close or how far they were from their goals. This is done on a daily, weekly, monthly basis and throughout the year. At the end of the academic year, a lifetime score 901 is created. This lifetime score becomes the starting point for the next academic year. In one embodiment of the invention, the highest lifetime score at high school graduation can be used to reward the adolescent for their exemplary involvement in performing physical activities. Similar to SAT and ACT scores offered after standardized testing, the TeenFitNation Lifetime score can be used to appreciate how physically active the adolescent has been through the years. Also, yearly scores can be used to set targets for the next year and so on.

Another example of creating a lifetime score can be explained as follows. First step in the system 100 is tracking an adolescent's physical activity on daily basis and classifying their physical activity level. This is done in relationship to their total energy expenditure (TEE) as a relationship to their basal energy expenditure (BEE) designated as the I-PAL. Second step is to track and map the physical activity level over a week and over a month and measure the achievement goal. The goal is for every adolescent to have a minimum score of 2 (Active) weekly and monthly. The system can also rewards points for adolescents and older teenagers who consistently enter the physical activity in to the system, in addition to rewards for actual physical activities conducted. This allows the individual to increase their lifetime score consistently.

In this specific example 900, the adolescent has reached 54% of his/her achievement target and needs to be encouraged to increase the achievement level initially to a reasonable level (for example 90%) with the goal of achieving 100%. Third step the activity level is tracked across the school year and reward points are set at trimester checkpoints. Parent/guardians or the school system can determine when they want to reward the adolescent and also set the achievement target at 100% or at 90% as listed in this example.

Also in this example 900, the adolescent has missed his/her target at first and second trimester but achieved the target 90% achievement at 3^{rd} trimester. In addition to this every subject has a lifetime score that they accumulate. The lifetime score transcends school year and belongs to the teenager till they turn 18.

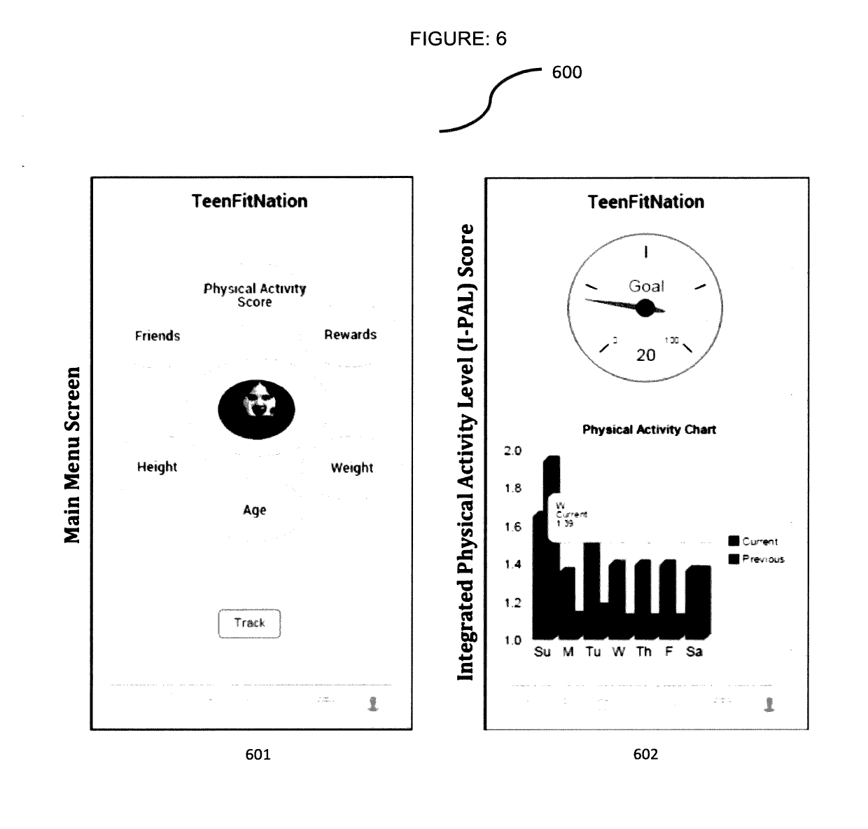

Another aspect of the invention 100 offers Rewards to adolescents who have achieved their physical activity goals. A reward sub-system 105 is a way to track and monitor adolescent's physical activity levels on a daily, weekly and monthly basis and rewards them on achieving milestones. lncentivizing adolescents on achieving milestones boosts morale and encourages them to engage in more physical activity and track those activities through our portal. As described before, the lifetime score goal can be set-up in subsystem 104 and as describe in FIG. 6. The user interface 151 can provide a graphical representation 603 of the adolescent's lifetime score and their path to the next goal. The location of the adolescent in the journey can be represented and as they progress towards achieving their goal, their movement can be graphically represented. The User Interface 600 also has aspects 602 for the adolescent to view their I-PAL daily, weekly or monthly and their progress towards their goal. Additional features such as a dashboard 601 and logging their physical activities 604 are depicted. For those skilled in the art, additional functionalities and features to create a better user experience can be envisioned.

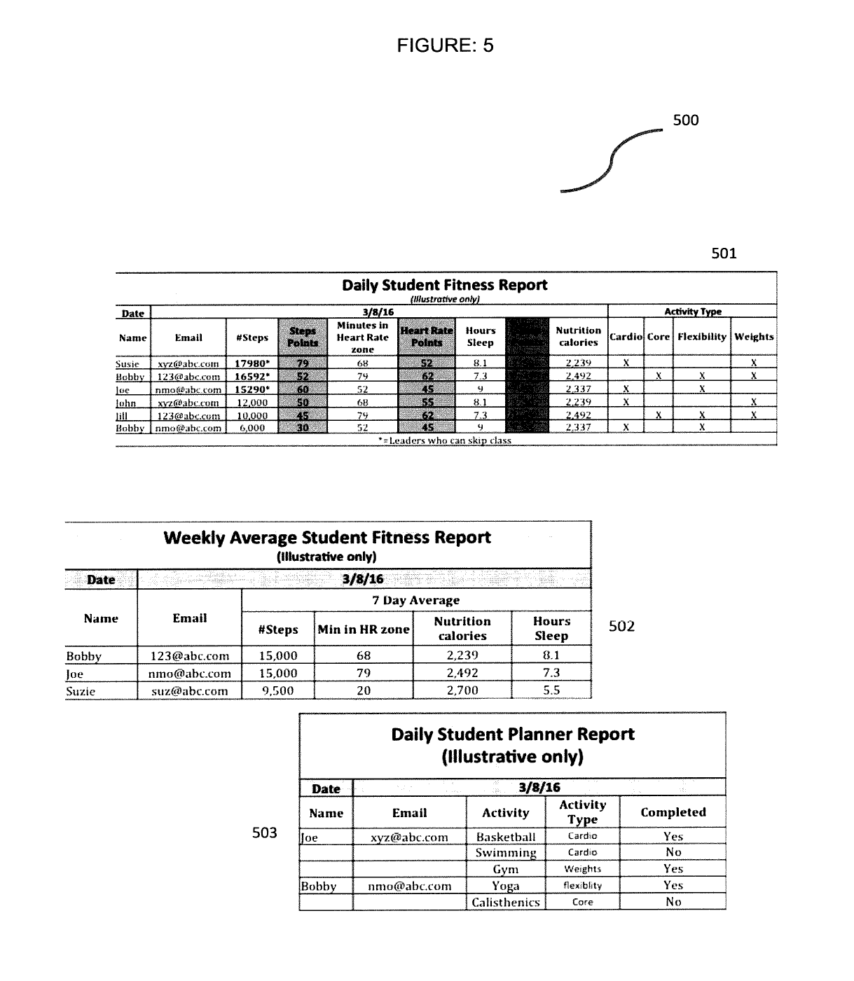

In one aspect of the rewards system 106, adolescents within a class in a school can be used as an example as shown in FIG. 5. The class roster 500 can be generated based on the physical activities conducted by the students. The physical activities can include before-school, in-school, after-school sports and activities of daily living. The I-PAL can be generated for each individual student or raw data associated with each activity can be compared. Example 501 shows the daily fitness report of a class of students, whereas 502 shows the weekly fitness report for the same class. As described before, 503 offer a day-in-the-life of the student to schedule their physical activity events over a day, week or month.

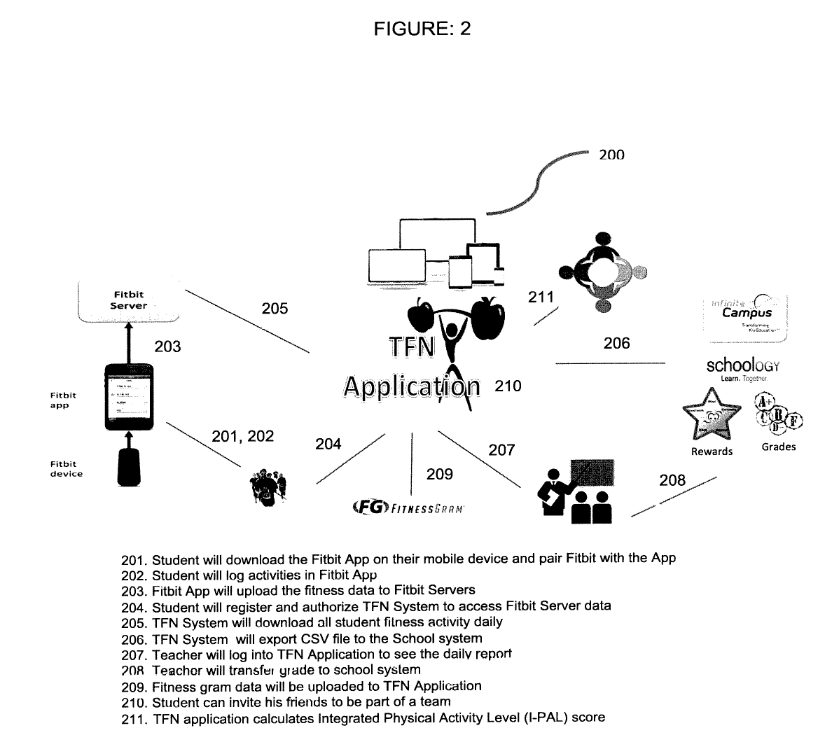

Additional embodiments can be used to describe the invention 100 being used in specific environments. The invention 100, can be incorporated in schools, youth clubs, boys and girls scouts, camps, sports teams and the like. FIG. 2 describes a school environment 200 where the invention is used to track students in a class. The process of utilizing the invention can be divided into 11 steps, each offering the ability to enhance the user experience. This embodiment utilizes an automated fitness tracker for young adults. As described before, adolescents can enter their physical activities manually. The student registers the tracking device into the system 100 using steps 201, 202 and 205. The system 100 then continues to track the daily physical activities of the student, while having the ability to share the information with their teacher through step 207 where individual goals can be set. The system 100 predicts the I-PAL for the student as described in step 210. The system 100 also allows the teacher to grade the student on their physical activity level and communicate it to software systems such as Infinite Campus, Schoology using step 206 and 208. If the student wishes to socialize his/her scores, he can invite other students to be friends using step 211.

The system 200 allows for a fully integrated solution in a school to track, monitor and reward students. Detailed reports like 501, 502 and 503 can be created to easily interpret the class performance. Additionally a peer group environment where adolescent students can create a peer group to track their group activity and set group rewards can be created. Comparisons can then be made between students of different classes, between different schools, between different school districts, between different states and even between different countries.

Detailed descriptions of the embodiments as shown above relate to the tracking, measuring, monitoring and rewarding the daily physical activities performed by adolescents. These embodiments could include gamification, commonly used in the software industry to create a game surrounding the objective. In this case, the objective is to motivate the adolescent and young adult to increase their daily physical activity level. Gaminication can come in many forms such as offering a game to play, portraying their progress in a game where every time they achieve their goals, they move to the next level in the game etc. Gamification can also be offered where teams or friends have a healthy competition playing the game, where each team gains points as they achieve their goals. Alternatively, gamification can be in the form of tracking and measuring their I-PAL as they walk through a park or take a bicycle ride though the neighborhood and the system 100 tracks them on a GPS system, makes them go on a treasure hunt, direct them towards a reward that they can get. This can be done individually or as a team where multiple members start at different locations but converge at the treasure hunt. For those skilled in the art, gamification can take many forms and are not limited by the descriptions offered here.

Another important aspect of the invention is the ability to use the daily physical activity level as a means and method to track and improve the overall health of the adolescent. General health tracking has been described and explained. The foregoing examples will describe specific health conditions that require adolescents to have an active lifestyle to maintain good health.

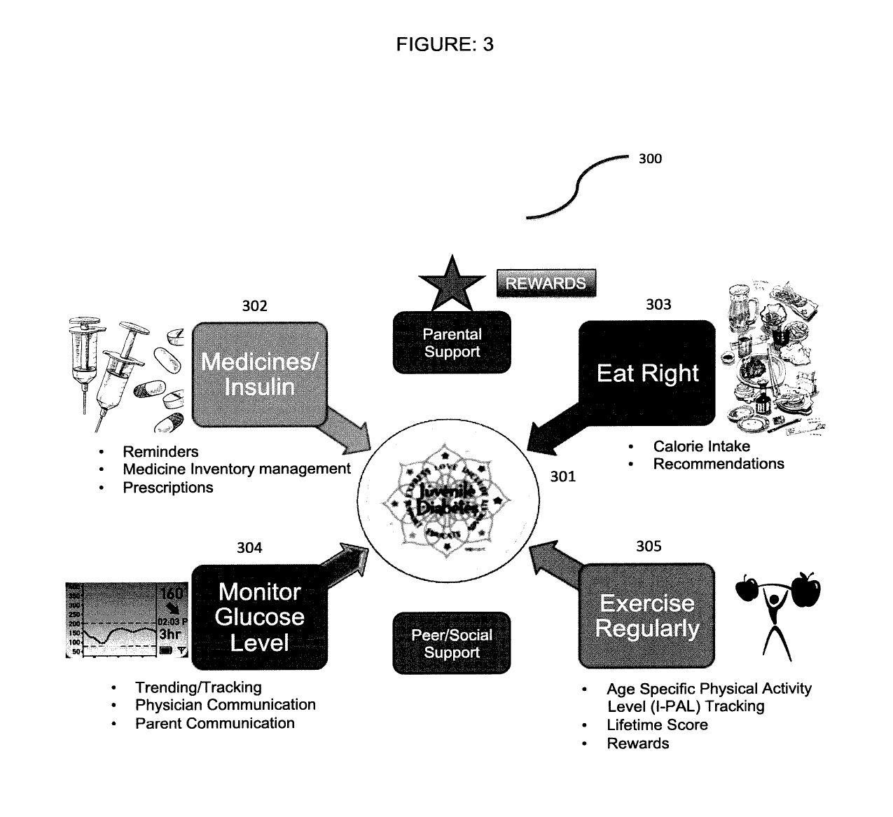

One such embodiment is described in FIG. 3. In 2012, it is estimated that 1.25 million children were diagnosed with Juvenile Diabetes and this number is expected to grow. Though the exact reasons for Type 1 juvenile diabetes among adolescents in unknown, the reason for Type 2 juvenile diabetes can be related to physical inactivity, diet and childhood obesity. In fact, Type 2 diabetes among adolescents is defined as a co-morbidity to obesity. Type 2 diabetes in adolescents could resolve itself while Type 1 diabetes cannot.

System 300 describes the invention where the four pillars associated with Juvenile diabetes are addressed. FIG. 3 shows the four pillars being described as (1) right medicines/insulin, (2) monitoring glucose levels, (3) eating right and (4) exercising regularly. The system 301, comprises of sub-systems to manage the medicines/insulin 302, track and monitor the glucose levels at regular intervals 303, a sub-system to track the eating habits of the adolescent 304 and a system similar to track to physical activity level 305. These sub-systems work together to offer a comprehensive view of the adolescent's health condition. Monitoring each of these four pillars is critical to the health of the adolescent with juvenile diabetes. For example, taking the medicines/insulin regularly at specified times; eating the right foods and staying away from sugary foods and performing a prescribed set of physical activities are critical.

Managing the calorie intake and calorie expenditure for adolescents is very difficult since their dietary needs vary daily depending on their linear and ponderal growth. This growth does not follow a straight line as each adolescent has different growth spurts. Due to this reason, a standardized approach is not possible. Accurate TEE can be predicted using the invention 100, which can be incorporated in 305 to predict the I-PAL for the adolescent with juvenile diabetes. This I-PAL can then be used to estimate the food intake for the adolescent. For diabetes patients, the type of food intake is also of concern as they need to limit the amount of sugary food. The type of food and I-PAL can then be used to monitor the glucose levels before and after eating and physical activities. The food intake, I-PAL and the glucose levels can then be used to define the medicine dosage for the adolescent.

The integration of accurate I-PAL to mange juvenile diabetes is novel and unique, as it has not been attempted before. The ability to track the medicines, monitor glucose levels and track food intake have been disclosed individually but integrating them with accurate I-PAL allows for proper monitoring by the child's pediatrician and parents. It is well known in the field of medicine, that exercise allows for extra sugars to be consumed by the body and accurately tracking the physical activity levels allows for proper prediction of glucose levels.

Motivating the adolescent to be healthy is critical. As adolescents, they do not comprehend the importance of eating right and exercising regularly. Specifically, for juvenile diabetes patients, the awareness of the criticality of the disease is minimal. It is essential to motivate the patients to manage the four pillars as explained. Offering rewards to the adolescents as they achieve their goals related to eating right and exercising regularly can help them maintain a good health. Individual goals can be set and team goals can be set with friends to maintain a good glucose level and limiting the use of medications. The parents, peers, teachers and mentors can offer rewards.

Juvenile diabetes can be a debilitative disease if not properly addressed. This invention addresses the relationship between the four pillars of juvenile diabetes and allows for proper tracking, measuring, monitoring and rewarding daily physical activities to maintain a normal glucose level.

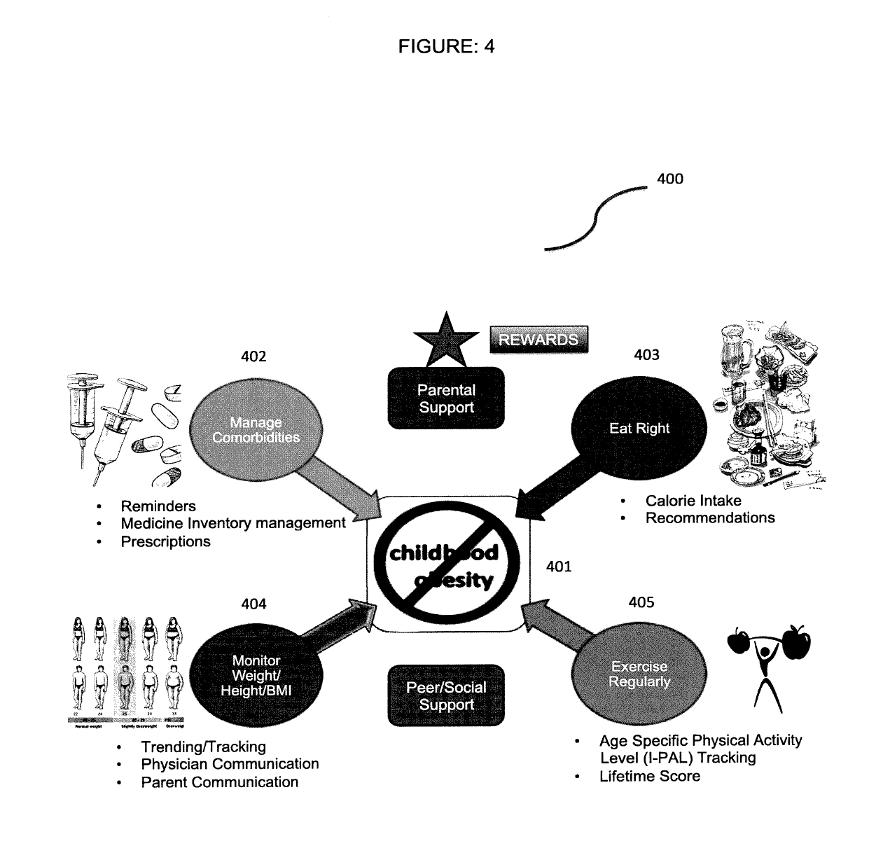

Another such embodiment related to maintaining medical health is described in FIG. 4. In 2016, it is estimated that 17% of the children in the U.S. are diagnosed as Obese and this number is expected to grow. Physical inactivity and diet and mentioned as the leading cause for childhood obesity. Childhood obesity can lead to other co-morbidities such as Type 2 diabetes, high blood pressure etc.

System 400 describes the invention where the four pillars associated with Childhood Obesity are addressed. The four pillars are being described as (1) manage comorbidities, (2) monitoring weight, (3) eating right and (4) exercising regularly. The system 401 comprises of sub-systems to manage comorbidities 402, track and monitor the weight 403, a sub-system to track the eating habits of the adolescent 404 and a system to track to physical activity level 405. These sub-systems work together to offer a comprehensive view of the adolescent's health condition. Monitoring each of these four pillars is critical to the health of the adolescent with childhood diabetes. For example, managing comorbidities by taking the medicines/insulin regularly at specified times; eating the right foods, staying away from sugary and fat foods and performing a prescribed set of physical activities are critical.

Managing the calorie intake and calorie experidilure for adolescents Is very difficult since their dietary needs vary daily depending on their linear and ponderal growth. This growth does not follow a straight line as each adolescent has different growth spurts. Due to this reason, a standardized approach is not possible. Accurate TEE can be predicted using the invention 100, which can be incorporated in 405 to predict the I-PAL for the adolescent with juvenile diabetes. This I-PAL can then be used to estimate the food intake for the adolescent. The food and I-PAL can then be used to monitor the weight. The food intake, I-PAL and the weight can then be used to define the medicine dosage for the adolescent to reduce comorbidities.

The integration of accurate I-PAL to mange childhood obesity is novel and unique as it has not been attempted before. The ability to track the medicines for comorbidities, monitor glucose levels and track food intake have been disclosed individually but integrating them with accurate I-PAL allows for proper monitoring by the child's pediatrician and parents. It is well known in the field of medicine, that exercise allows for extra sugars to be consumed by the body and accurately tracking the physical activity levels allows for proper prediction of glucose levels if such comorbidity is found.

Motivating the adolescent to be healthy is critical. As adolescents, they do not comprehend the importance of eating right and exercising regularly. Specifically, for childhood obesity patients, the awareness of the criticality of the disease is minimal. It is essential to motivate the patients to manage the four pillars as explained. Offering rewards to the adolescents as they achieve their goals related to eating right and exercising regularly can help them maintain a good health. Individual goals can be set and team goals can be set with friends to maintain a good glucose level and limiting the use of medications. The parents, peers, teachers and mentors can offer rewards.

Childhood obesity can be a debilitative disease if not properly addressed. This invention addresses the relationship between the four pillars of childhood obesity and allows for proper tracking, measuring, monitoring and rewarding daily physical activities to maintain or achieve a normal weight.

While the invention has been illustrated and described in detail in the drawings and foregoing description, the same is to be considered as illustrative and not restrictive in character, it being understood that only the preferred embodiments has been shown and described and that all changes and modifications that come within the spril of the invention are desired to be protected.

1. A method for monitoring health comprising:
a) creating a group of individuals to receive activity updates;
b) monitoring activities of the individuals within the group using one or more electronic input devices that measure one or more of movements, locations, and biometric or vital signs or each individual within the group; and
c) periodically and automatically reporting the monitored activities to the group through an internet enabled device.

2. A system for monitoring health comprising:
a) web-enabled program hosted on a server for creating a group of individuals to receive activity updates; and
b) input devices used or worn by the individuals for posting health metrics to web-enabled program over the internet, wherein the web enabled program periodically and automatically sends the activity updates to each individual within the group based on the metrics posted.
